(19) United States
(12) Patent Application Publication
(10) Pub. No.: US 2013/0271512 A1
(43) Pub. Date: Oct. 17, 2013

(54) THREE-DIMENSIONAL DISPLAY DEVICE AND METHOD FOR DRIVING THE SAME

(71) Applicants: Chun-Chieh Chiu, Luzhu Township (TW); Hsiang-tan Lin, Keelung City (TW); Chien-hung Chen, New Taipei City (TW)

(72) Inventors: Chun-Chieh Chiu, Luzhu Township (TW); Hsiang-tan Lin, Keelung City (TW); Chien-hung Chen, New Taipei City (TW)

(73) Assignee: CHUNGHWA PICTURE TUBES, LTD., Taoyuan (TW)

(21) Appl. No.: 13/484,303

(22) Filed: May 31, 2012

(30) Foreign Application Priority Data
Apr. 17, 2012 (TW) 101113668

(51) Int. Cl. G09G 5/10

(52) U.S. Cl. 345/691

(57) ABSTRACT

Disclosed are a three-dimensional display device and a method for driving the same. The three-dimensional display device is driven with a two-frame inversion and includes a display panel, a timing controller, a gamma voltage generator, and at least one source driver circuit. The display panel has a plurality of pixels. The timing controller of the present invention provides two different groups of gamma voltages for the gamma voltage generator, so that charging conditions of each of the pixels tend to be the same when switching frames.

### TECHNICAL FIELD OF THE INVENTION

The present invention relates to a three-dimensional display device, and more particularly to a three-dimensional display device and a method for driving the same.

### BACKGROUND OF THE INVENTION

In a three-dimensional (3D) display device, left-eye images and right-eye images are alternately provided for forming three-dimensional images. Accordingly, a double frame rate is required. Please refer to FIG. 1, which illustrates polarities of pixel voltages of pixels in continuous frames when a conventional three-dimensional display device is driven with a one-frame inversion. The one-frame inversion means that the polarities of the pixel voltages are inverted every frame.

Frames N and N+2 are utilized for displaying the left-eye images, while frames N+1 and N+3 are utilized for displaying the right-eye images. The pixel voltages for the same pixel in the left-eye images of the frames N and N+2 have the same polarity, while the pixel voltages for the same pixel in the right-eye images of the frames N+1 and N+3 also have the same polarity. Since the pixel voltages for the same pixel in the images of the same eye have the same polarity, mura phenomenon occurs.

Please refer to FIG. 2, which illustrates waveforms of the pixel voltage of a pixel and a common voltage. The common voltage V_{COM} is assumed to be 6 volts. When a gate turn-on voltage V_{G} turns on a gate line, the pixel voltage V_{P} in the left-eye image of the frame N is 11 volts. A voltage difference between the pixel voltage V_{P} in the left-eye image of the frame N and the common voltage V_{COM} is 5 volts. The pixel voltage V_{P} in the right-eye image of the frame N+1 is 5 volts. A voltage difference between the pixel voltage V_{P} in the right-eye image of the frame N+1 and the common voltage V_{COM} is 1 volt. Since the sum of the two voltage differences is not zero (i.e. is not balanced), image sticking phenomenon occurs when switching the frames.

To solve the above-mentioned problems, referring to FIG. 3 and FIG. 4, FIG. 3 illustrates polarities of the pixel voltages in continuous frames when a three-dimensional display device is driven with a two-frame inversion, and FIG. 4 illustrates waveforms of the pixel voltages and the common voltage. It can be understood from FIG. 3 that the two-frame inversion means that the polarities of the pixel voltages are inverted every two frames. Accordingly, the pixel voltages for the same pixel in the left-eye images of the frames N and N+2 have opposite polarities, and the pixel voltages for the same pixel in the right-eye images of the frames N+1 and N+3 also have opposite polarities. Since the pixel voltages for the same pixel in the images of the same eye have opposite polarities, the mura phenomenon in the one-frame inversion driving of FIG. 1 can be avoided.

As shown in FIG. 4, the common voltage V_{COM} is assumed to be 6 volts. When a gate turn-on voltage V_{G} turns on a gate line, the pixel voltage V_{P} in the left-eye image of the frame N is 11 volts. A voltage difference between the pixel voltage V_{P} in the left-eye image of the frame N and the common voltage V_{COM} is 5 volts. The pixel voltage V_{P} in the right-eye image of the frame N+1 is 7 volts. A voltage difference between the pixel voltage V_{P} in the right-eye image of the frame N+1 and the common voltage V_{COM} is 1 volt. The pixel voltage V_{P} in the left-eye image of the frame N+2 is 1 volt. A voltage difference between the pixel voltage V_{P} in the left-eye image of the frame N+2 and the common voltage V_{COM} is 5 volts. The pixel voltage V_{P} in the right-eye image of the frame N+3 is 5 volts. A voltage difference between the pixel voltage V_{P} in the right-eye image of the frame N+3 and the common voltage V_{COM} is 1 volt. Since the sum of the four voltage differences is approximately equal to zero (i.e. is balanced), the image sticking phenomenon in FIG. 2 can be improved when switching the frames.

Please refer to FIGS. 5A-5D. FIG. 5A illustrates waveforms of the pixel voltage and the common voltage at a gray level of 128. FIG. 5B illustrates waveforms of the pixel voltage and the common voltage at a gray level of 32. FIG. 5C and FIG. 5D respectively illustrate waveforms of the pixel voltage and the common voltage when switching gray levels.

In FIG. 5A, the frames N and N+1 are driven with a positive polarity (i.e. the pixel voltage V_{P} in the frame N and the pixel voltage V_{P} in the frame N+1 is higher than the common voltage V_{COM}) and has a gray level of 128. Theoretically, the pixel voltage V_{P} in the left-eye image of the frame N and the pixel voltage V_{P} in the right-eye image of the frame N+1 should be charged to a voltage V1. However, the pixel voltage V_{P} in the left-eye image of the frame N is practically charged only to a voltage V1−. This is because the pixel voltage V_{P} in the frame N is driven with the positive polarity, but the pixel voltage V_{P} in a previous frame is driven with a negative polarity (i.e. the pixel voltage V_{P} in the previous frame is lower than the common voltage V_{COM}). That is, the pixel voltage V_{P} in the frame N and the pixel voltage V_{P} in the previous frame are driven with opposite polarities, and thus the pixel voltage V_{P} in the frame N is not charged to the voltage V1. In contrast, the pixel voltage V_{P} in the frame N+1 and the pixel voltage V_{P} in the previous frame (i.e. the frame N) of the frame N+1 are driven with the same polarity, so the pixel voltage V_{P} in the frame N+1 is charged to the voltage V1. The rest may be deduced by analogy. The pixel voltage V_{P} in the left-eye image of the frame N+2 is charged only to a voltage V2−, but the pixel voltage V_{P} in the right-eye image of the frame N+3 is charged to a voltage V2.

FIG. 5B shows an example of the gray level of 32. The pixel voltage V_{P} in the left-eye image of the frame N is charged to only a voltage V3−, but the pixel voltage V_{P} in the right-eye image of the frame N+1 is charged to a voltage V3. The pixel voltage V_{P} in the left-eye image of the frame N+2 is charged to only a voltage V4−, but the pixel voltage V_{P} in the right-eye image of the frame N+3 is charged to a voltage V4. The same problem exists in both FIG. 5B and FIG. 5A.

In FIG. 5C, when the pixel voltage V_{P} in the left-eye image of the frame N is corresponding to the gray level of 32 (i.e. an initial gray level of the left-eye image) and the pixel voltage V_{P} in the right-eye image of the frame N+1 is corresponding to the gray level of 128 (i.e. an initial gray level of the right-eye image), a voltage difference between the pixel voltage V_{P} in the left-eye image of the frame N and the common voltage V_{COM} minus a voltage difference between the pixel voltage V_{P} in the right-eye image of the frame N+1 and the common voltage V_{COM} is:

|V3−−V_{COM}|−|V1−V_{COM}|=A

In FIG. 5D, when the pixel voltage V_{P} in the right-eye image of the frame N+1 is corresponding to the gray level of 32 (i.e. a target gray level of the right-eye image) and the pixel voltage V_{P} in the left-eye image of the frame N+2 is corresponding to the gray level of 128 (i.e. a target gray level of the left-eye image), a voltage difference between the pixel voltage V_{P} in the left-eye image of the frame N+2 and the common voltage V_{COM} minus a voltage difference between the pixel voltage VP in the right-eye image of the frame N+1 and the common voltage V_{COM} is:

|V4−V_{COM}|−|V_{COM}−V2−|=B

It can be seen from FIG. 5A and FIG. 5B that A is not equal to B. Accordingly, when the left-images and the right-eye images use the same overdrive table (OD table), crosstalk phenomenon occurs.

Therefore, there is a need for a solution to the above-mentioned problem of the crosstalk phenomenon caused by the pixel voltages which are insufficiently charged when the frames are driven with the two-frame inversion.

### SUMMARY OF THE INVENTION

An objective of the present invention is to provide a three-dimensional display device and a method for driving the same, which are capable of solving the problem of the crosstalk phenomenon caused by the pixel voltages which are insufficiently charged when the frames are driven with the two-frame inversion.

To achieve the above-mentioned objective, a three-dimensional display device according to an aspect of the present invention is driven with the two-frame inversion. The three-dimensional display device comprises a display panel, a timing controller, a gamma voltage generator, and at least one source driving circuit. The display panel comprises a plurality of pixels. The timing controller provides an image data and provides a first group of gamma voltages or a second group of gamma voltages. A voltage difference between each of the second group of gamma voltages and a common voltage is greater than a voltage difference between each of the first group of gamma voltages and the common voltage for the same gray level. The gamma voltage generator selects and outputs the first group of gamma voltages or the second group of gamma voltages according to each of the pixels. The source driving circuit drives each of the pixels according to the image data and according to the first group of gamma voltages or the second group of gamma voltages which is outputted by the gamma voltage generator. The timing controller provides the first group of gamma voltages for the gamma voltage generator when driving with the same polarity in a previous frame and in a current frame for each of the pixels. The timing controller provides the second group of gamma voltages for the gamma voltage generator when driving with opposite polarities in the previous frame and in the current frame for each of the pixels.

To achieve the above-mentioned objective, in a method for driving a three-dimensional display device according to another aspect of the present invention, the three-dimensional display device is driven with a two-frame inversion and comprises a display panel. The display panel comprises a plurality of pixels. The method comprises: providing an image data; providing a first group of gamma voltages when driving with the same polarity in a previous frame and in a current frame for each of the pixels, or providing a second group of gamma voltages when driving with opposite polarities in the previous frame and in the current frame for each of the pixels, a voltage difference between each of the second group of gamma voltages and a common voltage being greater than a voltage difference between each of the first group of gamma voltages and the common voltage for the same gray level; selecting and outputting the first group of gamma voltages or the second group of gamma voltages according to each of the pixels; and driving each of the pixels according to the image data and according to the first group of gamma voltages or the second group of gamma voltages.

The timing controller of the present invention provides two different groups of gamma voltages, so that charging conditions of each of the pixels tend to be the same when switching frames

### BRIEF DESCRIPTION OF THE DRAWINGS

FIG. 1 illustrates polarities of pixel voltages of pixels in continuous frames when a conventional three-dimensional display device is driven with a one-frame inversion;

FIG. 2 illustrates waveforms of the pixel voltage of a pixel and a common voltage when a three-dimensional display device is driven with a one-frame inversion;

FIG. 3 illustrates polarities of the pixel voltages in continuous frames when a three-dimensional display device is driven with a two-frame inversion;

FIG. 4 illustrates waveforms of the pixel voltages and the common voltage when a three-dimensional display device is driven with a two-frame inversion;

FIG. 5A illustrates waveforms of the pixel voltage and the common voltage at a gray level of 128;

FIG. 5B illustrates waveforms of the pixel voltage and the common voltage at a gray level of 32;

FIG. 5C and FIG. 5D respectively illustrate waveforms of the pixel voltage and the common voltage when switching gray levels;

FIG. 6 illustrates a three-dimensional display device according to a preferred embodiment of the present invention;

FIG. 7 illustrates curves of the first and second groups of gamma voltages;

FIG. 8A illustrates waveforms of the pixel voltage and the common voltage at a gray level of 128 after implementing the present invention

FIG. 8B illustrates waveforms of the pixel voltage and the common voltage at a gray level of 32 after implementing the present invention

FIG. 8C and FIG. 8D respectively illustrate waveforms of the pixel voltage and the common voltage after implementing the present invention when switching gray levels; and

FIG. 9 illustrates a flow chart of a method for driving a three-dimensional display device according to the present invention.

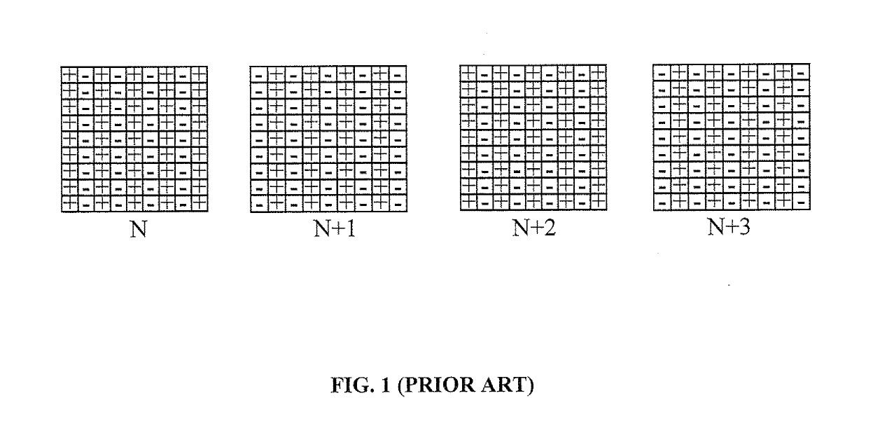

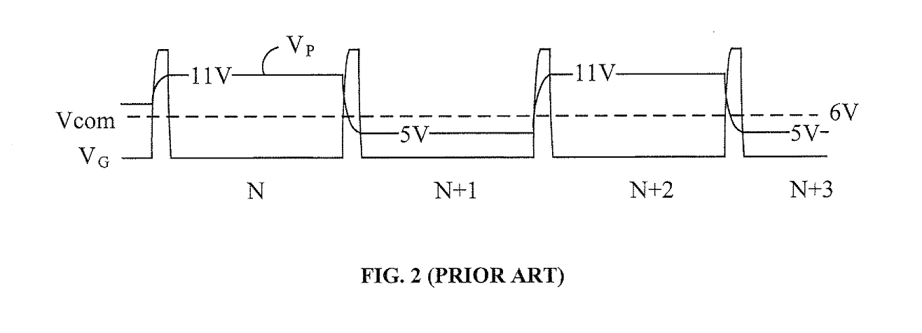

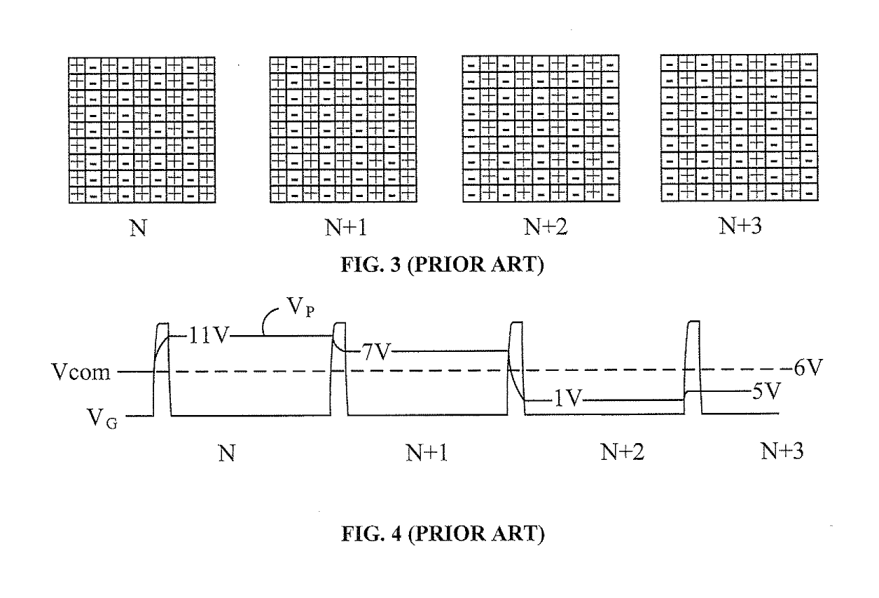

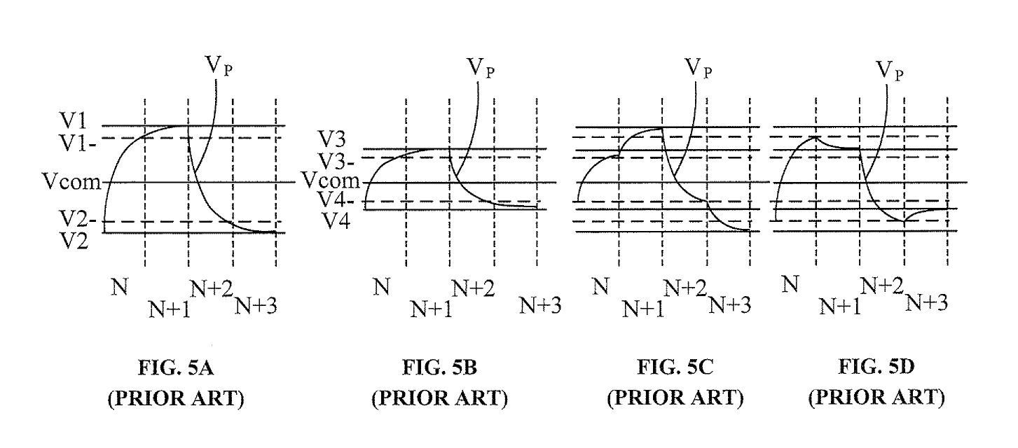

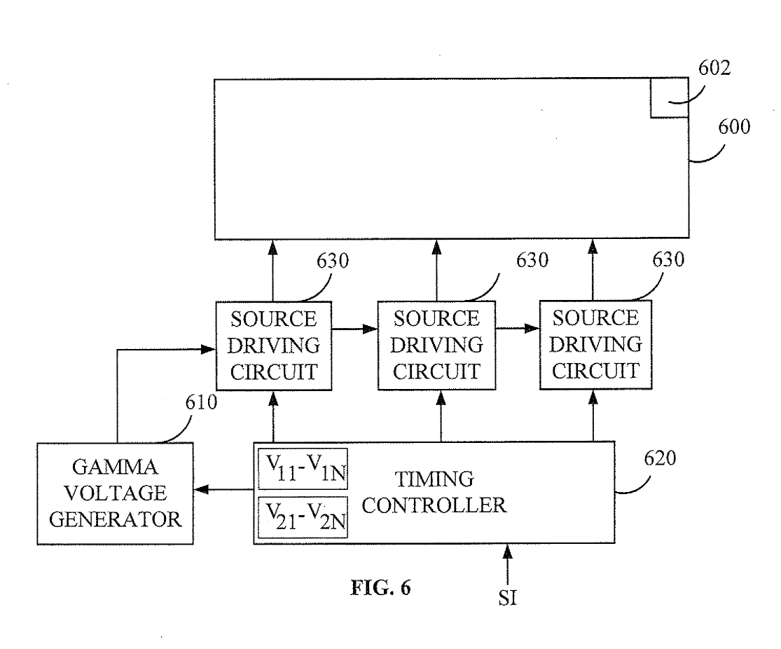

### DETAILED DESCRIPTION OF THE INVENTION

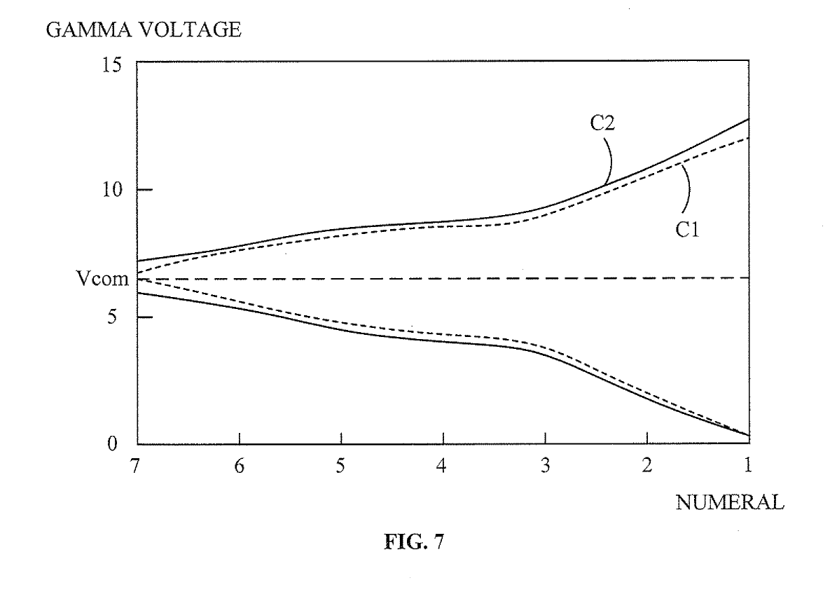

Please refer to FIG. 6, which illustrates a three-dimensional display device according to a preferred embodiment of the present invention.

The three-dimensional display device comprises a display panel 600, a gamma voltage generator 610, a timing controller 620, and at least one source driving circuit 630. There are three source driving circuits 630 in the present embodiment.

The three-dimensional display device of the present invention is driven with a two-frame inversion and at a fixed frame rate. The display panel is utilized for alternately displaying a left-eye image and a right-eye image and comprises a plurality of pixels (a pixel denoted as 602 in FIG. 6). The timing controller 602 receives a system input signal SI, provides an image data for the source driving circuits 630 according to the system input signal SI, and provides a first group of gamma voltages V₁₁-V_{1N} or a second group of gamma voltages V₂₁-V_{2N} for the gamma voltage generator 610. The image data comprises a required gray level for each pixel 602.

The system input signal SI is a low voltage differential signal (LVDS) or an embedded DisplayPort (eDP) signal.

In the present embodiment, the gamma voltage generator 610 may be a programmable integrated circuit. The timing controller 620 writes the first group of gamma voltages V₁₁-V_{1N} or the second group of gamma voltages V₂₁-V_{2N} in the gamma voltage generator 610 via an inter-integrated circuit (I2C) interface. The gamma voltage generator 610 selects and outputs the first group of gamma voltages V₁₁-V_{1N} or the second group of gamma voltages V₂₁-V_{2N} to the source driving circuits 630. N is a positive integer.

The source driving circuits 630 drive each pixel 602 according to the image data transmitted by the timing controller 620 and according to the first group of gamma voltages V₁₁-V_{1N} or the second group of gamma voltages V₂₁-V_{2N} outputted by the gamma voltage generator 610.

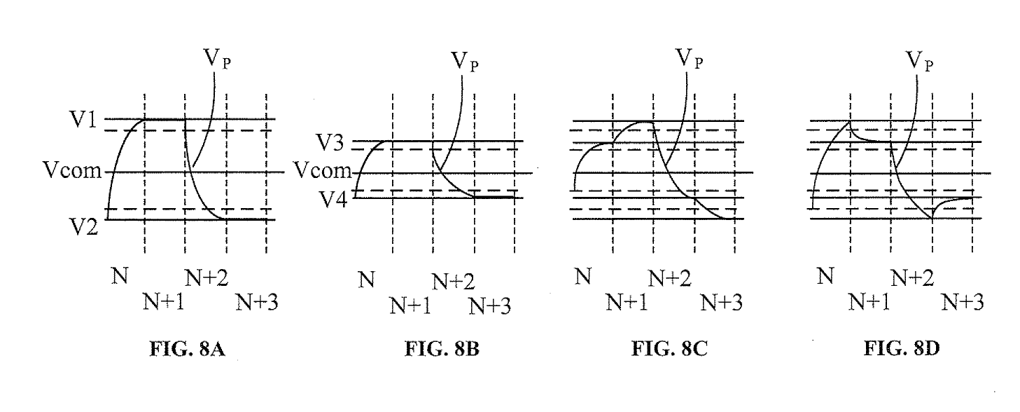

Please refer to FIG. 6 and FIG. 7. FIG. 7 illustrates curves of the first and second groups of gamma voltages. The curve C1 of the first group of gamma voltages and the curve C2 of the second group of gamma voltages respectively comprise 14 gamma voltages. Numerals 1-7 are respectively corresponding to different gray levels. The same gray level (i.e. the same numeral) of the same group (C1 or C2) is corresponding to two gamma voltages. When the gamma voltage is greater than the common voltage V_{COM}, this means that the three-dimensional display device is driven with a positive polarity. When the gamma voltage is smaller than the common voltage V_{COM}, this means that the three-dimensional display device is driven with a negative polarity. It can be seen from FIG. 7 that for the same gray level (i.e. the same numeral), a voltage difference between a gamma voltage of the curve C2 of the second group of gamma voltages and the common voltage V_{COM} is greater than a voltage difference between a gamma voltage of the curve C 1 of the first group of gamma voltages and the common voltage V_{COM}.

When the pixel 602 is driven with opposite polarities in a previous frame and in a current frame so that the pixel 602 is insufficiently charged, the timing controller 620 provides the second group of gamma voltages V₂₁-V_{2N} (i.e. each of the gamma voltages of the curve C2 of the second group of gamma voltages) for the gamma voltage generator 610. By providing a higher gamma voltage, the pixel 602 is compensated for the insufficient charging of the pixel 602. When the pixel 602 is driven with the same polarity in the previous frame and in the current frame, the timing controller 620 provides the first group of gamma voltages V₁₁-V_{1N} (i.e. each of the gamma voltages of the curve C1 of the first group of gamma voltages) for the gamma voltage generator 610.

It is noted that the curve C1 of the first group of gamma voltages and the curve C2 of the second group of gamma voltages may be obtained by performing experiments on the display panel 600.

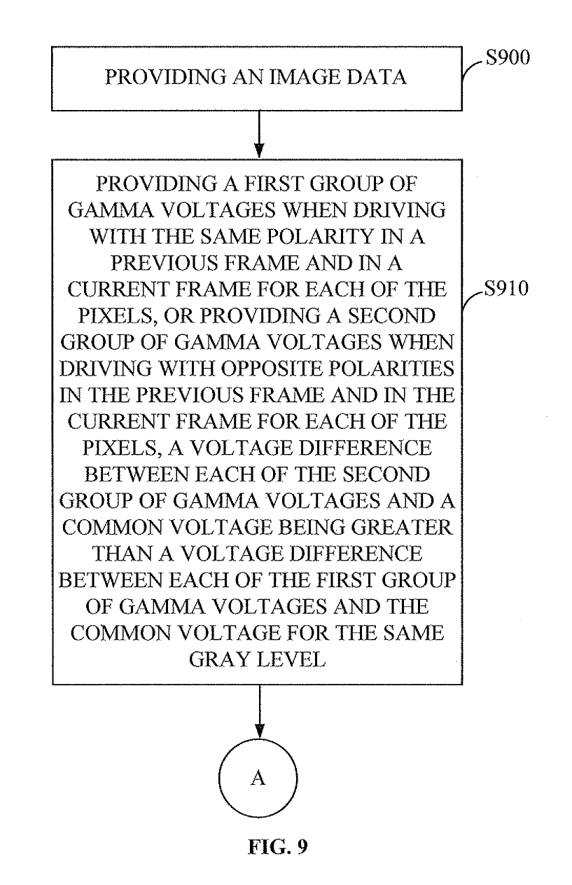

Please refer to FIG. 6, FIG. 7, and FIGS. 8A-8D. FIG. 8A illustrates waveforms of the pixel voltage and the common voltage at a gray level of 128 after implementing the present invention. FIG. 8B illustrates waveforms of the pixel voltage and the common voltage at a gray level of 32 after implementing the present invention. FIG. 8C and FIG. 8D respectively illustrate waveforms of the pixel voltage and the common voltage after implementing the present invention when switching gray levels.

In FIG. 8A, the pixel 602 is driven with the positive polarity in the frame N, while the pixel 602 is driven with the negative polarity in a previous frame of the frame N. Since the pixel 602 is driven with opposite polarities in the frame N and the previous frame, the timing controller 620 provides the second group of gamma voltages V₂₁-V_{2N} (i.e. each of the gamma voltages of the curve C2 of the second group of gamma voltages) for the gamma voltage generator 610 in the frame N. The pixel 602 is driven with the same polarity in the frame N+1 and in the frame N, so the timing controller 620 provides the first group of gamma voltages V₁₁-V_{1N} (i.e. each of the gamma voltages of the curve C1 of the first group of gamma voltages) for the gamma voltage generator 610 in the frame N+1. As a result, the pixel voltage V_{P} of the pixel 602 in the frame N and the pixel voltage V_{P} of the pixel 602 in the frame N+1 tend to be the same, that is, the pixel voltage V_{P} of the pixel 602 in the frame N and the pixel voltage V_{P} of the pixel 602 in the frame N+1 can be charged to the voltage V1. The rest may be deduced by analogy. The pixel 602 is driven with the opposite polarities in the frame N+2 and in the frame N+1, and thus the timing controller 620 provides the second group of gamma voltages V₂₁-V_{2N} (i.e. each of the gamma voltages of the curve C2 of the second group of gamma voltages) for the gamma voltage generator 610 in the frame N+2. The pixel 602 is driven with the same polarity in the frame N+3 and in the frame N+2, so the timing controller 620 provides the first group of gamma voltages V₁₁-V_{1N} (i.e. each of the gamma voltages of the curve C1 of the first group of gamma voltages) for the gamma voltage generator 610 in the frame N+3. As a result, the pixel voltage V_{P} of the pixel 602 in the frame N+2 and the pixel voltage V_{P} of the pixel 602 in the frame N+3 tend to be the same, that is, the pixel voltage V_{P} of the pixel 602 in the frame N+2 and the pixel voltage of the pixel 602 in the frame N+3 can be charged to the voltage V2.

FIG. 8B shows an example of the gray level of 32. By providing two different groups of gamma voltages, the pixel voltage V_{P} of the pixel 602 in the frame N and the pixel voltage V_{P} of the pixel 602 in the frame N+1 can be charged to the voltage V3, and the pixel voltage V_{P} of the pixel 602 in the frame N+2 and the pixel voltage V_{P} of the pixel 602 in the frame N+3 can be charged to the voltage V4. The operating principle in FIG. 8B is the same as that in FIG. 8A and thus is not repeated herein.

In FIG. 8C, when the pixel voltage V_{P} in the frame N is corresponding to the gray level of 32 (i.e. an initial gray level of the left-eye image) and the pixel voltage V_{P} in the frame N+1 is corresponding to the gray level of 128 (i.e. an initial gray level of the right-eye image), a voltage difference between the pixel voltage V_{P} in the left-eye image of the frame N and the common voltage V_{COM} minus a voltage difference between the pixel voltage V_{P} in the right-eye image of the frame N+1 and the common voltage V_{COM} is:

|V3−V_{COM}|−|V1−V_{COM}|=C

In FIG. 8D, when the pixel voltage V_{P} in the right-eye image of the frame N+1 is corresponding to the gray level of 32 (i.e. a target gray level of the right-eye image) and the pixel voltage V_{P} in the left-eye image of the frame N+2 is corresponding to the gray level of 128 (i.e. a target gray level of the left-eye image), a voltage difference between the pixel voltage V_{P} in the left-eye image of the frame N+2 and the common voltage V_{COM} minus a voltage difference between the pixel voltage V_{P} in the right-eye image of the frame N+1 and the common voltage V_{COM} is:

|V4−V_{COM}|−|V_{COM}−V2|=D

It can be seen from FIG. 8A and FIG. 8B that C is equal to D. Accordingly, when the left-images and the right-eye images use the same overdrive table (OD table), the crosstalk phenomenon in the prior art may be avoided.

In another embodiment, the gamma voltage generator 610 may be a programmable integrated circuit having a built-in memory. The built-in memory is capable of in advance storing the first group of gamma voltages V₁₁-V_{1N} and the second group of gamma voltages V₂₁-V_{2N} which are provided by the timing controller 620. After the timing controller 620 receives the system input signal SI, the timing controller 620 controls the gamma voltage generator 610 to select and output the first group of gamma voltages V₁₁-V_{1N} or the second group of gamma voltages V₂₁-V_{2N} which is stored in advance.

It is noted that after the timing controller 620 receives the system input signal SI, a blank time is inserted between two frames so as to write the first group of gamma voltages V₁₁-V_{1N} or the second group of gamma voltages V₂₁-V_{2N} in the gamma voltage generator 610 or so as to control the gamma voltage generator 610 to select and output the first group of gamma voltages V₁₁-V_{1N} or the second group of gamma voltages V₂₁-V_{2N} which is stored in advance.

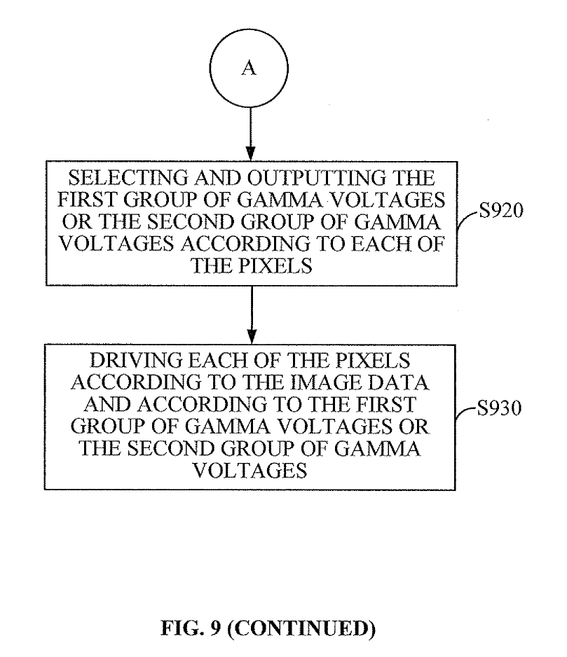

Please refer to FIG. 9, which illustrates a flow chart of a method for driving a three-dimensional display device according to the present invention. The three-dimensional display device comprises a display panel. The display panel comprises a plurality of pixels. The method comprises the following steps.

In step S900, an image data is provided. The image data is provided according to a system input signal.

In step S910, a first group of gamma voltages is provided when the pixels are driven with the same polarity in a previous frame and in a current frame, or a second group of gamma voltages is provided when the pixels are driven with opposite polarities in the previous frame and in the current frame. A voltage difference between each of the second group of gamma voltages and a common voltage is greater than a voltage difference between each of the first group of gamma voltages and the common voltage for the same gray level. The first group of gamma voltages or the second group of gamma voltages is provided according to the system input signal.

The above-mentioned system input signal is a low voltage differential signal or an embedded DisplayPort signal

In step S920, the first group of gamma voltages or the second group of gamma voltages is selected and outputted according to each of the pixels.

In step S930, each of the pixels is driven according to the image data and according to the first group of gamma voltages or the second group of gamma voltages.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A three-dimensional display device, which is driven with a two-frame inversion, the three-dimensional display device comprising:
a display panel, comprising a plurality of pixels;
a timing controller, providing an image data and providing a first group of gamma voltages or a second group of gamma voltages, a voltage difference between each of the second group of gamma voltages and a common voltage being greater than a voltage difference between each of the first group of gamma voltages and the common voltage for the same gray level;
a gamma voltage generator, selecting and outputting the first group of gamma voltages or the second group of gamma voltages according to each of the pixels; and
at least one source driving circuit, driving each of the pixels according to the image data and according to the first group of gamma voltages or the second group of gamma voltages which is outputted by the gamma voltage generator,
the timing controller providing the first group of gamma voltages for the gamma voltage generator when driving with the same polarity in a previous frame and in a current frame for each of the pixels,
the timing controller providing the second group of gamma voltages for the gamma voltage generator when driving with opposite polarities in the previous frame and in the current frame for each of the pixels.

2. The three-dimensional display device of claim 1, wherein the timing controller provides the image data and provides the first group of gamma voltages or the second group of gamma voltages according to a system input signal.

3. The three-dimensional display device of claim 2, wherein the system input signal is a low voltage differential signal or an embedded DisplayPort signal.

4. The three-dimensional display device of claim 1, wherein the gamma voltage generator is a programmable integrated circuit, and the timing controller writes the first group of gamma voltages or the second group of gamma voltages in the gamma voltage generator.

5. The three-dimensional display device of claim 4, wherein the timing controller writes the first group of gamma voltages or the second group of gamma voltages in the gamma voltage generator via an inter-integrated circuit interface.

6. The three-dimensional display device of claim 1, wherein the gamma voltage generator is a programmable integrated circuit having a built-in memory for storing the first group of gamma voltages and the second group of gamma voltages which are provided by the timing controller.

7. A method for driving a three-dimensional display device, the three-dimensional display device being driven with a two-frame inversion and comprising a display panel, the display panel comprising a plurality of pixels, the method comprising:
providing an image data;
providing a first group of gamma voltages when driving with the same polarity in a previous frame and in a current frame for each of the pixels, or providing a second group of gamma voltages when driving with opposite polarities in the previous frame and in the current frame for each of the pixels, a voltage difference between each of the second group of gamma voltages and a common voltage being greater than a voltage difference between each of the first group of gamma voltages and the common voltage for the same gray level;
selecting and outputting the first group of gamma voltages or the second group of gamma voltages according to each of the pixels; and
driving each of the pixels according to the image data and according to the first group of gamma voltages or the second group of gamma voltages.

8. The method for driving the three-dimensional display device of claim 7, wherein the image data is provided according to a system input signal, and the first group of gamma voltages or the second group of gamma voltages is provided according to the system input signal.

9. The method for driving the three-dimensional display device of claim 8, wherein the system input signal is a low voltage differential signal or an embedded DisplayPort signal.
